(19) United States
(12) Patent Application Publication
(10) Pub. No.: US 2008/0032183 A1
(43) Pub. Date: Feb. 7, 2008

(54) COATED SUPPORT MATERIAL FOR USE IN FABRICATING A FUEL CELL MATRIX AND METHOD OF FORMING SAME USING ALKALINE PRECURSORS

(76) Inventors: Gengfu Xu, Danbury, CT (US); Chao-Yi Yuh, New Milford, CT (US)

Correspondence Address: COWAN LIEBOWITZ & LATMAN, P.C;JOHN J TORRENTE, 1133 AVENUE OF THE AMERICAS, NEW YORK, NY, 10036, US

(21) Appl. No.: 11/462,810

(22) Filed: Aug. 7, 2006

(51) Int. Cl. H01M 8/14; B05D 5/12

(52) U.S. Cl. 429/46; 427/115

(57) ABSTRACT

A method of making a coated support material for use in fabricating a fuel cell matrix, comprising providing a support material, providing an alkaline precursor material, the alkaline precursor material being one of soluble in water and having a melting point of 400° C. or less, mixing the support material and the alkaline precursor material to form a mixture, and processing the mixture to cause the alkaline precursor material to coat the support material to form the coated support material.

### BACKGROUND OF THE INVENTION

This invention relates to fuel cells and, in particular, to coated materials for use in fabricating an electrolyte matrix for use in fuel cells.

A fuel cell is a device which directly converts chemical energy stored in hydrocarbon fuel into electrical energy by means of an electrochemical reaction. Generally, a fuel cell comprises an anode and a cathode separated by an electrolyte, which serves to conduct electrically charged ions. In order to produce a useful power level, a number of individual fuel cells are stacked in series with an electrically conductive separator plate between each cell.

Molten carbonate fuel cells (“MCFCs”) operate by passing a reactant fuel gas through the anode, while oxidizing gas is passed through the cathode. The anode and the cathode of MCFCs are isolated from one another by a porous electrolyte matrix which is saturated with carbonate electrolyte. The matrix typically comprises a porous, unsintered LiAlO₂ ceramic powder bed impregnated with molten alkali carbonate electrolyte and provides ionic conduction and gas sealing. During MCFC operation, the matrix experiences both mechanical and thermal stresses which contribute to cracking or defects in the matrix. In order to provide effective gas sealing, the electrolyte matrix must have sufficient strength, mechanical integrity and materials endurance to withstand these stresses, particularly during thermal cycles of the MCFC. In particular, the matrix must be able to accommodate volume changes associated with carbonate melting and solidification during MCFC thermal cycling, to provide resistance to pressure differences across the matrix and to wet seal holding pressure over long periods of time, and must have slow or no pore growth over MCFC lifetime. Moreover, the matrix must have sufficient porosity and sub-micron pore distribution to ensure strong capillary forces so as to effectively retain electrolyte within its pores to prevent flooding of the electrodes and the drying out of the matrix.

Accordingly, various methods of manufacturing an electrolyte matrix having increased strength and improved electrolyte retention characteristics have been developed. In particular, starting materials for manufacturing the matrix, which typically comprise a combination of ceramic and carbonate materials in powder or particulate form, have a considerable effect on the strength and electrolyte retention characteristics of the matrix. For example, U.S. Pat. No. 4,526,812 discloses use of a coated powder comprising ceramic particles coated with carbonate electrolyte for manufacturing an electrolyte matrix. In the '812 patent, the coated powder is formed by heating a mixture of carbonate electrolyte and ceramic particles to melt the carbonate such that the carbonate coats the ceramic particles, and thereafter cooling the carbonate-coated particles to solidify the carbonate.

Another method of manufacturing an electrolyte matrix is disclosed in U.S. Pat. No. 5,869,203, assigned to the same assignee herein, and uses a mixture of ceramic support material and additive material for manufacturing the matrix. In the '203 patent, the mixture of ceramic support material and additive material is formed by mixing ceramic support material and an additive material using a high-energy intensive milling technique of the support and additive materials to produce highly active particles of smaller size. In particular, the high-energy milling technique of the '203 patent is carried out by adding the additive material to a slurry of the support material and milling the slurry mixture such that the particle size of the additive is less than 0.5 μm. The matrix is then formed from the slurry mixture by a tape casting technique.

The method disclosed in the '812 patent suffers from a number of disadvantages. In particular, the use of high temperatures in order to melt the carbonate electrolyte to form the coated ceramic powder in the '812 patent may result in coarsening of the ceramic particles. In addition, the ceramic particles may undergo phase transformation during the high temperature melting process. Moreover, high-temperature melting of the carbonate results in losses due to evaporation, thus making the specific amount of coating materials required in the mixture difficult to control. This, in turn, results in inconsistent formulation processes for subsequent batches.

The high-energy milling technique disclosed in the '203 patent has been effective in increasing the strength and uniformity of the electrolyte matrix. However, the high-energy milling technique is limited by the effectiveness of the milling process itself, which produces carbonate particles of varying sizes. Carbonate particles having a relatively large size, which may be present in the mixture after the milling process is performed, impair electrolyte retention in the matrix and result in increased surface roughness of the matrix after the electrolyte in the matrix melts. The increased surface roughness, in turn, contributes to increased interface contact resistance within the fuel cell.

It is therefore an object of the present invention to provide an improved method of fabricating the electrolyte matrix having higher porosity, greater particle packing and improved retention of electrolyte.

It is a further object of the invention to provide a method of fabricating the matrix which does not require use of a high temperature melting process to form coated ceramic particles.

It is another object of the invention to provide a method of fabricating the matrix which is cost effective, easily scalable and has a consistent formulation.

### SUMMARY OF THE INVENTION

In accordance with the principles of the present invention, the above and other objectives are realized in a method of making a coated support material for use in fabricating a fuel cell matrix comprising providing a support material, providing an alkaline precursor material, which is one of soluble in water and has a melting point of 400° C. or less, mixing the support material and the alkaline precursor material to form a mixture and processing the mixture such that the alkaline precursor material coats the support material to form the coated support material. The support material comprises a porous ceramic material, such as γ-LiAlO₂, α-LiAlO₂ and β-LiAlO₂. The alkaline precursor material comprises at least one of alkaline hydroxide, alkaline isopropoxide, alkaline nitrate, alkaline acetate and alkaline oxalate. In certain embodiments, the alkaline precursor material comprises at least one of lithium acetate, lithium acetate anhydrate, lithium oxalate, lithium nitrate and lithium hydroxide.

In certain embodiments in which the alkaline precursor material is soluble in water, the processing of the mixture to form the coated support material comprises dispersing the mixture in water so as to dissolve the alkaline precursor material in water, and drying the mixture so as to remove water and to form the coated support material. In such embodiments, the dispersing of the mixture in water comprises blending the mixture with a predetermined amount of water for a predetermined time period and drying comprises at least one of spray drying and heating for a predetermined time period (Spray Combustion Process). In certain illustrative embodiments, the support material comprises α-LiAlO₂ powder having a first predetermined particle size and the alkaline precursor material comprises lithium acetate powder having a second predetermined particle size, the mixture of the support material and the alkaline precursor material is dispersed in water by blending the mixture for 120 minutes and the dispersed mixture is dried by heating the mixture to 120° C. for a 24 hour time period and thereafter heating the mixture to 400° C. for a 1-hour time period under an air flow. The first predetermined particle size in such embodiments is 0.09 microns and the second predetermined particle size is 50 microns or less, and each of the support material and the alkaline precursor material comprise 50% of a total volume of the mixture.

In certain embodiments in which the alkaline precursor material has a melting point of 400° C. or less, the processing of the mixture to form the coated support material comprises heating the mixture to a predetermined temperature for a predetermined time period to melt the alkaline precursor material. The predetermined temperature is between 60 and 400° C. The processing further comprises cooling the mixture to room temperature after the heating. In certain illustrative embodiments, the support material comprises α-LiAlO₂ and the alkaline precursor material comprises lithium acetate powder, with the support material comprising 85% of a total volume of the mixture and the alkaline precursor material comprising 15% of the total volume. In such embodiments, the support material and the alkaline precursor are mixed using a blender for a time period of 30 minutes and the processing of the mixture comprises heating the mixture to 65° C. for 3 hours and thereafter heating the mixture to 180° C. for 3 hours and cooling the mixture to room temperature. In other illustrative embodiments, the support material comprises α-LiAlO₂ powder and the alkaline precursor material comprises lithium oxalate powder, the support material comprising 75% of a total volume of the mixture and the alkaline precursor material comprising 25% of the total volume. In such embodiments, the support material and the alkaline precursor material are mixed using a blender for a time period of 30 minutes and the processing of the mixture comprises heating the mixture to 300° C. for 3 hours and thereafter heating the mixture to 400° C. to 1 hour and cooling the mixture to room temperature.

The method of making the coated support material also comprises at least one of comminuting the formed coated support material and sieving the coated support material to eliminate particles larger than a predetermined size. In certain embodiments, comminuting of the coated support material comprises ball milling the coated support material using YTZ grinding media having a 6 mm diameter for a time period of 24 hours.

Coated support material, a method of fabricating a matrix element from the coated support material for use in a fuel cell system, and a fuel cell which includes an electrolyte matrix formed from the coated support material are also disclosed.

### BRIEF DESCRIPTION OF THE DRAWINGS

The above and other features and aspects of the present invention will become more apparent upon reading the following detailed description in conjunction with the accompanying drawings in which:

FIG. 1 shows a molten carbonate fuel cell including an electrolyte matrix formed from a coated support material;

FIG. 2A shows a flow diagram of one embodiment of a method for fabricating the coated support material;

FIG. 2B shows a flow diagram of another embodiment of a method for fabricating the coated support material;

FIG. 3 shows an illustrative example of a method for forming the electrolyte matrix of FIG. 1 using the coated support material fabricated using the methods of FIGS. 2A and 2B;

FIG. 4 shows a graph of particle size distribution of α-LiAlO₂ powder before and after performing the coating methods of FIGS. 2A and 2B;

FIG. 5 shows a graph of pore size distribution data for electrolyte matrix tapes fabricated from α-LiAlO₂ coated using the methods of FIGS. 2A and 2B;

FIG. 6 shows a graph of pore size distribution data for electrolyte matrix tapes fabricated from coated α-LiAlO₂;

FIGS. 7 and 8 show graphs of relative area resistance as a function of operating lifetime for single-cell fuel cells using conventional electrolyte matrices and using matrices formed from coated α-LiAlO₂ fabricated using methods of FIGS. 2A and 2B.

### DETAILED DESCRIPTION

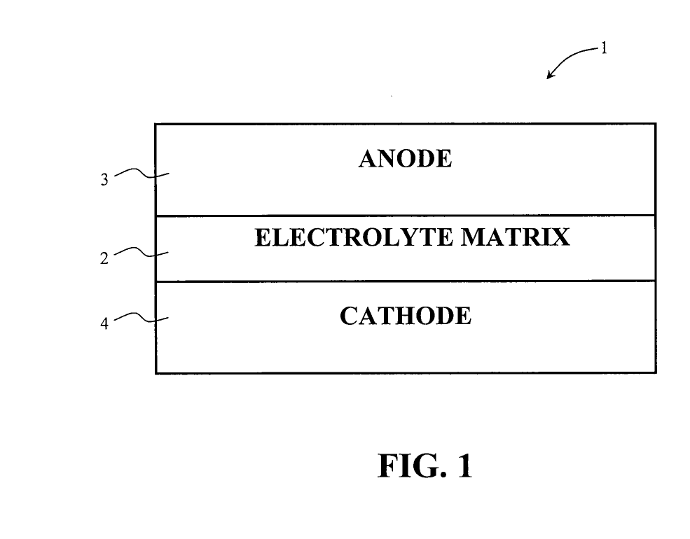

FIG. 1 shows a molten carbonate fuel cell 1 including an electrolyte matrix 2 fabricated in accordance with the principles of the present invention. The fuel cell 1 also includes an anode 3 and a cathode 4 which are separated from one another by the matrix 2. Fuel gas is fed to the anode 3 and oxidant gas is fed to the cathode 4. In the fuel cell, these gases undergo an electrochemical reaction in the presence of molten carbonate electrolyte present in the pores of the electrolyte matrix 2. The electrolyte typically comprises an alkali carbonate, such as Li₂CO₃, K₂CO₃ or Na₂CO₃.

The electrolyte matrix comprises a support material coated with alkaline precursors. The support material comprises a porous ceramic material having a sub-micron particle size. In this illustrative example, LiAlO₂, including γ-LiAlO₂, α-LiAlO₂ and β-LiAlO₂, are used as the support material.

The alkaline precursor material comprises an alkaline containing compound which has a low melting point and/or is soluble in water or in a predetermined solvent. Suitable alkaline containing precursors include alkaline hydroxides, alkaline isopropoxides, alkaline nitrates, alkaline acetates, alkaline oxalates and mixtures thereof. In particular, lithium acetate, lithium acetate dehydrate, lithium oxalate, lithium nitrate and lithium hydroxide are suitable for use as alkaline precursor materials.

In certain embodiments, the electrolyte matrix also comprises one or more additive components which may include binder, plasticizer and other suitable materials. It is also understood that other materials may be suitable for use in the electrolyte matrix 2 of the fuel cell 1.

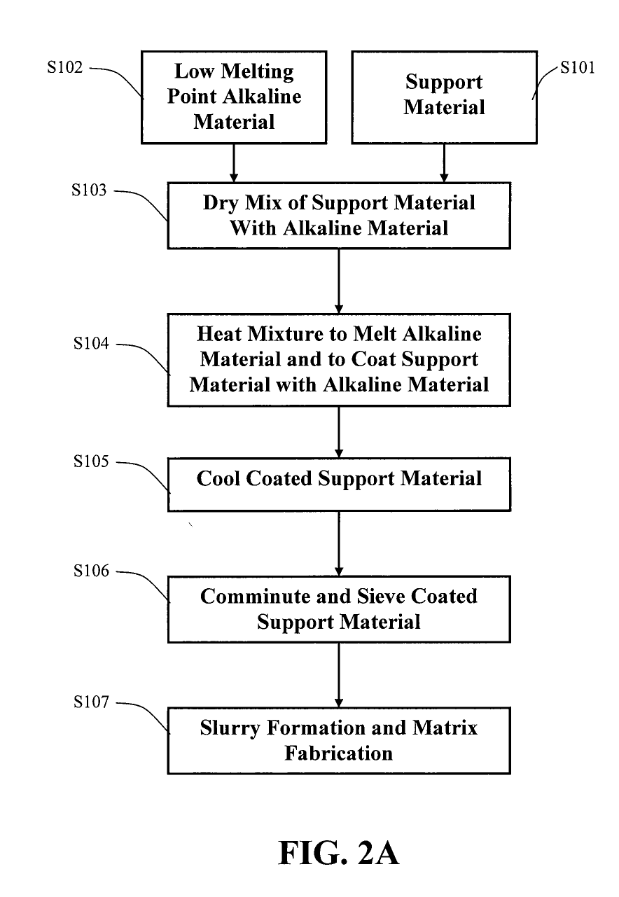

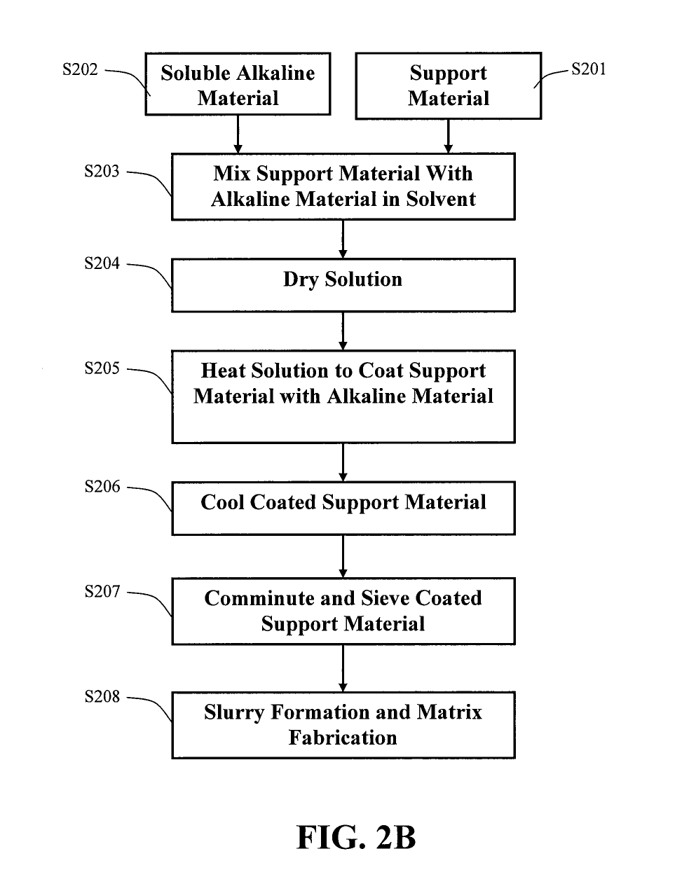

As above-indicated, the electrolyte matrix 2 of FIG. 1 is manufactured using a coated support material and, in particular, a support material coated with alkaline precursor material. FIG. 2A shows a flow diagram of a method for fabricating a coated support material which can then be used in manufacturing of the matrix 2.

As shown in FIG. 2A, in a first step S101, a first predetermined amount of support material is provided and in a second step S102, a second predetermined amount of an alkaline precursor material having a low melting point is provided. As mentioned herein above, LiAlO₂, including γ-LiAlO₂, α-LiAlO₂ and β-LiAlO₂, is suitable for use as the support material. The alkaline precursor material has a melting point below 400° C., and preferably between 50 and 400° C. Suitable alkaline precursor materials in this illustrative embodiment include lithium acetate having a melting point of about 58° C. or lithium nitrate having a melting point of about 264° C. The second predetermined amount of the alkaline precursor material is relative to the first predetermined amount of the support material. In particular, the second predetermined amount of alkaline precursor material, provided in step S102, is between 5 and 100 volume % of the first predetermined volume amount of the support material.

In this illustrative embodiment, the support material and the alkaline precursor material are provided in a powder form, such that the support material has a particle size of about 1 micron and the alkaline precursor material has a particle size of 50 microns or less. It is understood that the support material and the alkaline precursor material may be pre-milled to achieve the desired particle size.

In a third step S103, the support material provided in step S101 and the alkaline precursor material provided in step S102 are dry mixed for a first predetermined period of time to provide a relatively uniform mixture. Conventional methods, such as dry blending the materials in a blender, may be employed in the third step S103. In certain illustrative embodiments, the first predetermined period of time is about 30 minutes.

In the next steps the mixture of support material and alkaline precursor material is processed so that the alkaline precursor material coats the support material to form coated support material. In particular, in a fourth step S104, the mixture formed in the third step S103 is heated to a predetermined temperature for a second predetermined time period. The predetermined temperature is between 60° C. and 400° C. so as to melt the alkaline precursor material in the mixture without vaporizing or significantly decomposing the precursor material. The second predetermined time period is a time period sufficient to completely melt the alkaline precursor material and to coat the particles of the support material completely. In certain embodiments, the mixture may be heated again to a temperature higher than the predetermined temperature for a third predetermined time period so as to ensure that the molten alkaline precursor material completely coats the particles of the support material.

The heated mixture is thereafter allowed to cool in a fifth step S105 so as to solidify the alkaline precursor material coating the support material particles and to produce coated support material. The coated support material in this illustrative embodiment is allowed to cool to about room temperature. Although not shown in FIG. 2A, the cooled coated support material formed in S105 may be examined using SEM and BET measurements to determine the surface area and the particle size of the coated support material.

In step S106, cooled coated support material is comminuted and sieved to break apart any granules formed during the heating and cooling processes in steps S105 and S106 and to provide a relatively homogeneous powder. Comminution in step S106 may be achieved by dry milling the coated support material in a grinding jar or by using any other process known in the art. Sieving of the coated support material powder is performed in order to remove any large granules remaining after the comminution process is performed. In this way, the coated support material powder having a relatively uniform particle size and suitable for use in manufacturing the electrolyte matrix, is produced. As shown in FIG. 2A, the coated support material powder is then used in step S107 to form a slurry for fabrication of the electrolyte matrix 2.

As discussed herein above, the alkaline precursor material may be an alkaline material which is soluble in water or in another pre-selected solvent. FIG. 2B shows a flow diagram of a method for fabricating a coated support material using a soluble alkaline precursor material to coat the support material.

As shown in FIG. 2B, a first predetermined amount of the support material is provided in a first step S201 and a second predetermined amount of the soluble alkaline precursor material is provided in a second step S202. The first step S201 is similar to step S101 described herein above with respect to FIG. 1, and therefore a detailed description of this step will be omitted. As described above, the support material in this embodiment comprises LiAlO₂, including γ-LiAlO₂, α-LiAlO₂ and β-LiAlO₂, and has a particle size of about 1 micron.

As mentioned above, the alkaline precursor material is soluble in water or in another suitable solvent and has a particle size of about 50 microns or less. Suitable alkaline precursor materials include lithium oxalate and lithium hydroxide, both of which are soluble in water.

As discussed above, the second predetermined amount of the alkaline precursor material is relative to the first predetermined amount of the support material. In this illustrative embodiment, the second predetermined amount of alkaline precursor material, provided in step S202, is between 5 and 100 volume % of the first predetermined volume amount of the support material.

In the next step S203, the support material provided in step S201 and the alkaline precursor material provided in step S202 are mixed in a predetermined amount of solvent. The mixing in step S203 may be accomplished by blending the support material, the alkaline precursor material and the solvent using a blender for a predetermined time period or until the precursor material completely dissolves in the solvent. It is understood that any other suitable state-of-the-art mixing processes may be employed in step S203. The amount of solvent used in the mixture should be sufficient to completely dissolve the alkaline precursor material.

The mixture is then processed to cause the alkaline precursor material to coat the support material. Specifically, the solution produced in step S203 is then dried in step S204 to remove the solvent from the solution and to provide support material particles coated with the precursor material. Spray drying and/or heating, or another process known in the art, may be used to dry the solution in step S204. The resulting coated support material may also be heated in step S205 to a predetermined temperature for a predetermined time period in order to remove any remaining solvent from the mixture and to promote the coating of the support material with the alkaline precursor material. The heated coated support material is thereafter cooled in step S206.

In the next step S207, the coated support material produced in step S206 (or in step S204, if no heating is used) is comminuted and sieved so as to break apart or remove any large granules and to provide a substantially homogeneous powder comprising coated support material particles. This step S207 is similar to step S106 described herein above with respect to FIG. 2A, and thus a detailed description thereof is omitted. The coated support material powder produced in step S207 is suitable for use in manufacturing the electrolyte matrix, as shown in step S208 of FIG. 2B.

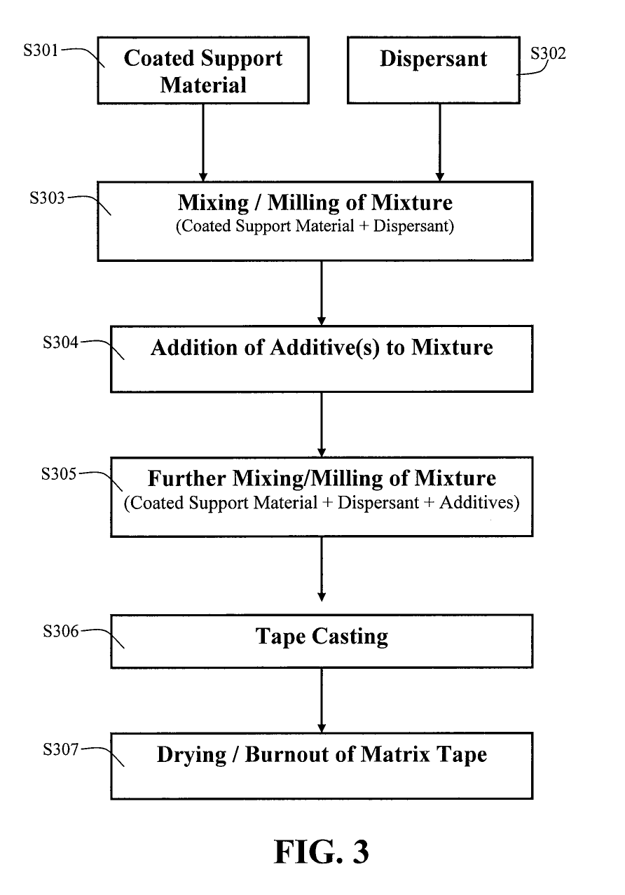

The coated support material prepared in accordance with methods shown in FIGS. 2A and 2B can be used to fabricate a porous electrolyte matrix for use in fuel cells (Steps S107 and S208 in FIGS. 2A and 2B). Various state-of-the art techniques may be used to manufacture the electrolyte matrix from the coated support material. An illustrative example of a method of slurry formation and electrolyte matrix fabrication using the coated support material is shown in FIG. 3 and described herein below.

As shown in FIG. 3, a predetermined amount of coated support material is provided in the first step S301. The coated support material is previously prepared in accordance with FIG. 2A or FIG. 2B. The amount of coated support material is dependent on a variety of factors such as the materials used in the coated support material, the desired size of the matrix, the size of the fuel cell and the number of matrices to be produced. In a second step S302, a sufficient amount of dispersant is provided so as to disperse the coated support material therein and to prevent re-agglomeration of coated support material particles. Suitable dispersants include organic solvents, fish oil or polymeric dispersants such as Hypermer KD-series polymeric dispersants. In certain embodiments, the dispersant may also include a binder material and/or other suitable materials. A suitable binder for use in the dispersant is an acryloid binder. The amount of dispersant and its composition may be varied based on the targeted surface area of the coated support material, the type of support material used, the particle size in the coated support material and other factors.

In a third step S303 of the matrix fabrication method, the coated support material provided in step S301 and the dispersant provided in step S302 are mixed so as to form a slurry mixture. In this step, the mixture of coated support material and the dispersant may be milled for a predetermined period of time to break down any agglomerates present and to ensure that the coated support material particles are uniformly dispersed throughout the slurry. The milling is accomplished using any state-of-the-art milling technique, such as ball milling, attrition milling or fluid energy grinding. For example, the slurry mixture may be milled using the ball milling technique using YTZ grinding media. The size of the grinding media is based on the desired particle size of the coated support material particles in the slurry.

In the next step S304, one or more additives are added to the slurry mixture. For example, aluminum powder may be added to the slurry mixture in step S304 as an additive for strengthening the electrolyte matrix. After the addition of the additives in S304, the resulting mixture is again mixed or milled in step S305. As in step S303, state-of-the-art mixing or milling techniques, such as ball milling, attrition milling or fluid energy milling may be used in step S303. The mixture is mixed/milled in S305 for a sufficient period until the additives become uniformly dispersed throughout the slurry mixture and any agglomerates present in the mixture are broken down.

Following the mixing/milling in step S305, the slurry is formed into one or more electrolyte matrix elements in step S306 of the method. The electrolyte matrix elements may be formed using any suitable state-of-the-art technique. In the illustrative example shown in FIG. 3, tape casting is the preferred technique for forming the matrix element, in which the slurry mixture is tape cast using a doctor blade. After the matrix element is formed in step S306, the matrix tape element is dried in step S307. The dry matrix tape element results in a flat and flexible tape having nearly 0% green porosity and nearly theoretical as-cast green density. The green tape may also undergo a burnout procedure in step S307 during which the tape is heated to a predetermined temperature for a predetermined time period so as to remove dispersant and to produce a completed matrix element. It is understood that in step S306, a plurality of matrix tape elements may be cast from the slurry so that a plurality of matrix elements are formed using the method of FIG. 3.

The completed matrix element formed using the method of FIG. 3 comprises the ceramic matrix 2 formed from the coated support material and the additive materials. [When the matrix element is used in the fuel cell, the coating on the particles of the support material is converted to alkaline carbonate electrolyte within the matrix. Thus, the coating on the particles defines the pore sizes in the matrix. When the alkaline coating material is converted to molten electrolyte, the electrolyte is retained in the matrix by capillary forces of the pores.

The optimal components and amounts of those components used to fabricate the coated support material and the components used in manufacturing the matrix using the above-described methods are dependent on the particular application and requirements of the fuel cell. Illustrative examples of fabricating the coated support material and manufacturing the electrolyte matrix are described herein below.

### EXAMPLE 1

In this illustrative example, α-LiAlO₂ powder is used as the support material in the matrix and lithium acetate powder is used as the alkaline coating material. The method shown in FIG. 2A and described above is used to prepare the coated support material and the method shown in FIG. 3 and described above is used to fabricate matrix elements for use in the fuel cell.

In the first step S101, the support material α-LiAlO₂ is provided in powder form having a particle size of about 0.1 micron and a surface area of about 10 m²/g. The predetermined amount of the α-LiAlO₂ material provided is about 85% of the total volume of the mixture. In the second step S102, the low melting point alkaline material lithium acetate de-hydrates with a melting point of about 58° C. is provided in powder form. Lithium acetate has a particle size of about 50 microns. The predetermined amount of lithium acetate provided is about 15% of the total volume of the mixture.

The α-LiAlO₂ support material and the lithium acetate material are dry mixed in the third step S103 by blending the mixture in a blender for about 30 minutes. The blended mixture of α-LiAlO ₂ and lithium acetate prepared in the third step S103 is heated in step S104 to about 65° Celsius for 3 hours so as to melt the lithium acetate to coat the α-LiAlO₂ support material. The mixture is thereafter heated to 180° C. for an additional 3 hour time period so as to drive off any water present in the mixture. The heated mixture formed in step S104 is then cooled to room temperature in step S105 to form coated α-LiAlO₂ support material. The coated α-LiAlO₂ support material is then examined using state-of-the-art SEM and BET techniques to determine the surface area and particle size of the coated α-LiAlO₂.

In the next step S106, the coated α-LiAlO₂ support material is comminuted using conventional dry milling in a grinding jar for a time period of 24 hours so as to grind any granules and produce a substantially homogeneous coated α-LiAlO₂ powder. The resulting coated α-LiAlO₂ powder then undergoes a conventional sieving operation so as to remove any large granules present in the powder which have not been ground by the dry milling operation.

The sieved coated α-LiAlO₂ support material is then used to form a slurry mix and to fabricate the matrix from the slurry mix. The method shown in FIG. 3 and described above is used to fabricate matrix elements for use in the fuel cell. In the first step S301, coated α-LiAlO₂ support material produced in step S106 of the method shown in FIG. 2A is provided. In the second step S302, a dispersant comprising an organic solvent and binder material is provided. In this illustrative example, the dispersant includes MEK/Cyclohexane as a suitable solvent and Acryloid B72 as a suitable binder material. The amount of the dispersant provided is such that the coated α-LiAlO₂ support material is completely dispersed therein.

The mixture of the coated α-LiAlO₂ and the dispersant is then milled in step S303 using a conventional ball milling technique to produce a slurry. The grinding media suitable for ball milling the mixture of the coated α-LiAlO₂ and the dispersant is YTZ grinding media having a 6 mm diameter. The mixture is milled for 24 hours, or until the coated α-LiAlO₂ is sufficiently dispersed in the dispersant. In the fourth step S304, aluminum powder is added as an additive to the slurry mixture. The amount of the aluminum powder additive is 9 wt % of the solids, and the particle size of the aluminum powder is preferably about 1-5 micron. The mixture of coated α-LiAlO₂ material, dispersant and aluminum powder is then milled in step S305 for a period of about 18 hours using ball milling with 6 mm YTZ grinding media. The resulting slurry mixture can then be used to fabricate matrix elements.

In this illustrative example, the matrix elements are fabricated from the slurry mixture prepared in step S305 using a tape casting technique. In particular, the slurry is tape cast using a doctor blade in step S306 and dried in step S307. The resulting matrix element is a flat and flexible green tape suitable for use in the fuel cell. It is understood that the size and the dimensions of the matrix element fabricated using this method will vary depending on the fuel cell requirements.

### EXAMPLE 2

In this illustrative example, α-LiAlO₂ powder is provided for use as the support material in the matrix and lithium oxalate powder is provided as the alkaline coating material. The method shown in FIG. 2A and described above is used to prepare the coated support material and the method shown in FIG. 3 and described above is used to fabricate one or more matrix elements from the coated support material in the fuel cell.

In the first step S101 of preparing the coated support material, the support material α-LiAlO₂ is provided in powder form. The α-LiAlO₂ support material has a particle size of about 0.1 micron and a surface area of about 10 m²/g. The predetermined amount of α-LiAlO₂ support material provided is about 75% of the total volume of the mixture. In the second step S102, the alkaline material lithium nitrate is provided in powder form. The lithium nitrate alkaline material has a particle size of about 50 micron and a surface are of about 10 m²/g. The predetermined amount of lithium nitrate material provided in this step is about 25% of the total volume of the mixture. It is understood that the total volume of the mixture depends on the number and size of the matrix elements to be manufactured using the coated support material.

In the third step S103, the α-LiAlO₂ support material and the lithium nitrate alkaline material are dry mixed, or dry blended, using a blender for about 30 minutes. The blended mixture is thereafter heated in step S104 to about 300° C. for a time period of about 3 hours in order to melt the lithium nitrate to coat the α-LiAlO₂ support material. The temperature of the mixture is then increased to about 400° C. at a rate of 5° C./min and the heating of the mixture is continued for an additional time period of about 1 hour at about 400° C. to complete the coating of the support material and to drive off any water present in the mixture. The heated mixture formed in step S104 is allowed to cool to room temperature in the fifth step S105, forming coated α-LiAlO₂ material. The resulting coated α-LiAlO₂ may be examined using state-of-the-art SEM and BET techniques to determine its surface area and particle size.

In step S106, the coated α-LiAlO₂ material is comminuted using the conventional dry milling technique. In particular, the coated α-LiAlO₂ material is dry milled in a grinding jar for 24 hours to grind away any granules and to form a substantially homogeneous coated α-LiAlO₂ powder. The milled coated α-LiAlO₂ powder is then sieved to remove any remaining large granules present in the powder.

The milled and sieved coated α-LiAlO₂ material produced in step S106 is then used in matrix fabrication using the method shown in FIG. 3 and described above. In the first step S301 of fabricating one or more matrix elements, coated α-LiAlO₂ powder, formed in step S106, is provided. In the second step S302, a dispersant comprising at least an organic solvent is provided. MEK and Cyclohexane is a suitable organic solvent which may be used in this example. In this illustrative example, the dispersant may also include binder material such as Acryloid B72. The amount of dispersant provided is such that the coated α-LiAlO₂ support material is sufficiently dispersed therein.

The mixture of coated α-LiAlO₂ and the dispersant formed in step S302 is then milled in step S303 using a conventional ball milling technique to produce a slurry. Ball milling is performed using YTZ grinding media having a 6 mm diameter for a period of about 24 hours, or until the coated α-LiAlO₂ is sufficiently dispersed in the dispersant. In the next step S304, aluminum powder is added as an additive to the slurry mixture. The amount of the aluminum powder used is about 9 wt % of the solids, and the particle size of the aluminum powder is about 1-5 micron. The mixture of the coated α-LiAlO₂, dispersant and aluminum powder is thereafter milled in step S305 for a period of 18 hours using the ball milling technique with the 6 mm YTZ grinding media. The resulting slurry mixture can be utilized in fabricating the matrix elements.

In this example, the matrix elements are formed from the slurry mixture formed in step S305 using the conventional tape casting technique. In particular, the slurry mixture is tape cast using a doctor blade in step S306 and dried in step S307 to form a flat and flexible green tape. As in the previous example, the dimensions of the matrix element fabricated using the method described above may vary depending on the requirements of the fuel cell system.

### EXAMPLE 3

In this illustrative example, α-LiAlO₂ powder is used as the support material in the matrix and lithium acetate powder is used as the alkaline coating material. The method shown in FIG. 2B and described above is used to prepare the coated support material and the method shown in FIG. 3 and described above is used to fabricate matrix elements for use in the fuel cell system.

In the first step S101 of preparing the coated support material, the support material α-LiAlO₂ is provided in powder form having a particle size of about 0.09 micron and a surface area of about 20.7 m²/g. The predetermined amount of α-LiAlO₂ provided in this step is about 50% of the total volume of the mixture. In the second step S102, water-soluble alkaline material lithium acetate is provided also in powder form. The water-soluble lithium acetate material used in this example preferably has a particle size of less than 50 microns and is provided in an amount of about 50% of the total volume of the mixture.

In the third step S103, the α-LiAlO₂ support material and the lithium acetate material are mixed in the presence of water as the solvent in a blender for about 120 minutes. After the mixing in step S103 is completed, the mixture is dried in step S104. In particular, the mixture of α-LiAlO₂ and lithium acetate dissolved in water is poured into a flat aluminum tray and heated to about 120° C. for about 24 hours to dry off the water present in the mixture. In the next step S105, the mixture is heated to about 400° C. at a rate of about 5° C./min and then heated at 400° C. for a time period of about 1 hour under an air flow so as to remove any water remaining in the mixture and to coat the α-LiAlO₂ particles with the aluminum acetate material. The dried mixture is then allowed to cool in step S106 to room temperature, resulting in a coated α-LiAlO₂ support material coated with lithium acetate. The coated α-LiAlO₂ may be examined using SEM and BET techniques to determine the surface area and particle size of the coated powder. In the next step S107, the coated α-LiAlO₂ is comminuted using the ball milling technique for about 24 hours to produce a substantially homogeneous coated α-LiAlO₂ support material. In particular, YTZ grinding media having 6 mm diameter is used for ball milling the coated α-LiAlO₂ powder. The resulting coated α-LiAlO₂ is then sieved in order to remove any large granules remaining in the α-LiAlO₂ powder.

The sieved coated α-LiAlO₂ support material can then be used to form a slurry mixture and to fabricate one or more matrix elements. The method shown in FIG. 3 and described above is used to form the slurry and to fabricate the matrix elements. The formation of the slurry and the matrix elements therefore is substantially similar to the formation of the slurry and matrix elements as described above in Examples 1 and 2, and detailed description thereof will be omitted.

The electrolyte matrix elements fabricated in accordance with the above described methods and examples had an improved pore structure and experienced no significant change in pore size after being used in the fuel cells. In particular, the electrolyte matrix elements produced using the above methods had a smaller mean pore size and a narrower pore size distribution as compared with conventional electrolyte matrix elements. Such improved pore structure results in improved mechanical strength and endurance of the matrix when used in the fuel cell and in greater electrolyte retention by the matrix. Moreover, the matrix elements produced in accordance with the above methods experienced significantly smaller pore growth after being used in the fuel cell. This results in improved electrolyte retention by the matrix during the operation and over the life of the fuel cell.

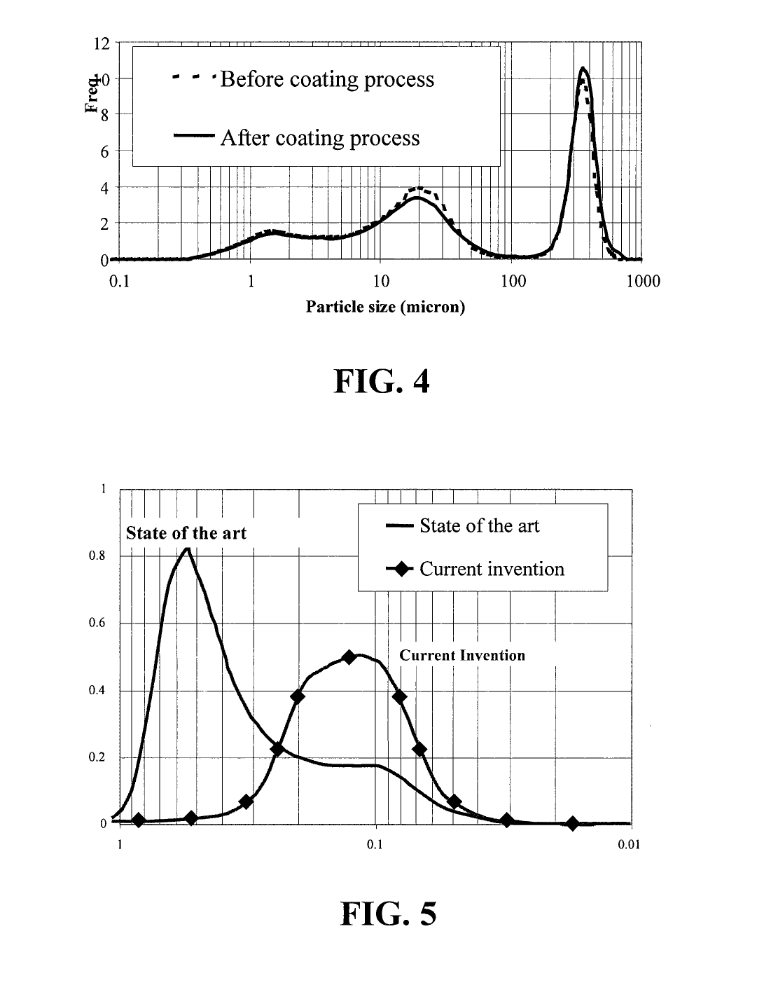

FIG. 4 shows a graph of particle size distribution of the α-LiAlO₂ powder before and after the coating process shown in FIGS. 2A and 2B. In FIG. 4, X-axis represents the particle size of the powder in microns while the Y-axis represents the frequency of the particles. As shown, the particle size distribution of the coated α-LiAlO₂ remains substantially the same as the particle size distribution of the uncoated α-LiAlO₂. As a result, the porosity of the matrix elements formed from the coated α-LiAlO₂ material is not dependent on the particle size of the electrolyte material, as in the conventional matrix elements, and is more uniform and has a narrower pore size distribution than the conventional matrix elements.

FIG. 5 shows a graph of pore size distribution data for electrolyte matrix tapes fabricated from the coated α-LiAlO₂ using the methods of FIGS. 2A and 2B and for conventional electrolyte matrix tapes prepared using the method of the '203 patent. The electrolyte matrix tapes were prepared using α-LiAlO₂ as the support material in either method. In both electrolyte matrix tapes, Li₂CO₃ was used as the electrolyte. The pore size distribution in each of the matrix tapes was determined after the tapes were used in the fuel cell for 100 hours operating at 650° C.

In FIG. 5, the X-axis of the graph represents the pore size of the matrix element in microns, while the Y-axis represents relative frequency of the pores. As shown in FIG. 5, the conventional matrix tapes had a broad pore size distribution with pores ranging between 0.4 and 1 microns in size. In particular, the conventional matrix tapes had a frequent occurrence of larger pores that are 0.25 to 0.7 microns in size. As also shown, the matrix tapes fabricated using the coated α-LiAlO₂ material formed using the methods of FIGS. 2A and 2B had a narrower, single-peak pore size distribution, with pores ranging between 0.03 and 0.4 microns, with most frequently occurring pores having a size between 0.07 and 0.25 microns. Thus, the matrix tapes fabricated from coated α-LiAlO₂ had significantly smaller pores than the conventional matrix tapes and a more uniform pore-size distribution. These improvements in the pore structure of the electrolyte matrix result in greater mechanical integrity of the matrix and improved electrolyte retention.

The matrix elements formed from the coated α-LiAlO₂ also showed no significant changes in porosity after being used in the fuel cell system. Pore size distribution of electrolyte matrix elements fabricated from coated α-LiAlO₂ and of conventional matrix elements was measured before using the matrix elements in cell tests. The matrix elements were thereafter used in fuel cell tests at an operating temperature of 650° C. for 100 hours, after which the pore size distribution of these matrix elements was measured. The pore size distribution of the matrix elements before use in cell tests was then compared with the pore size distribution of the matrix elements after being used in cell tests.

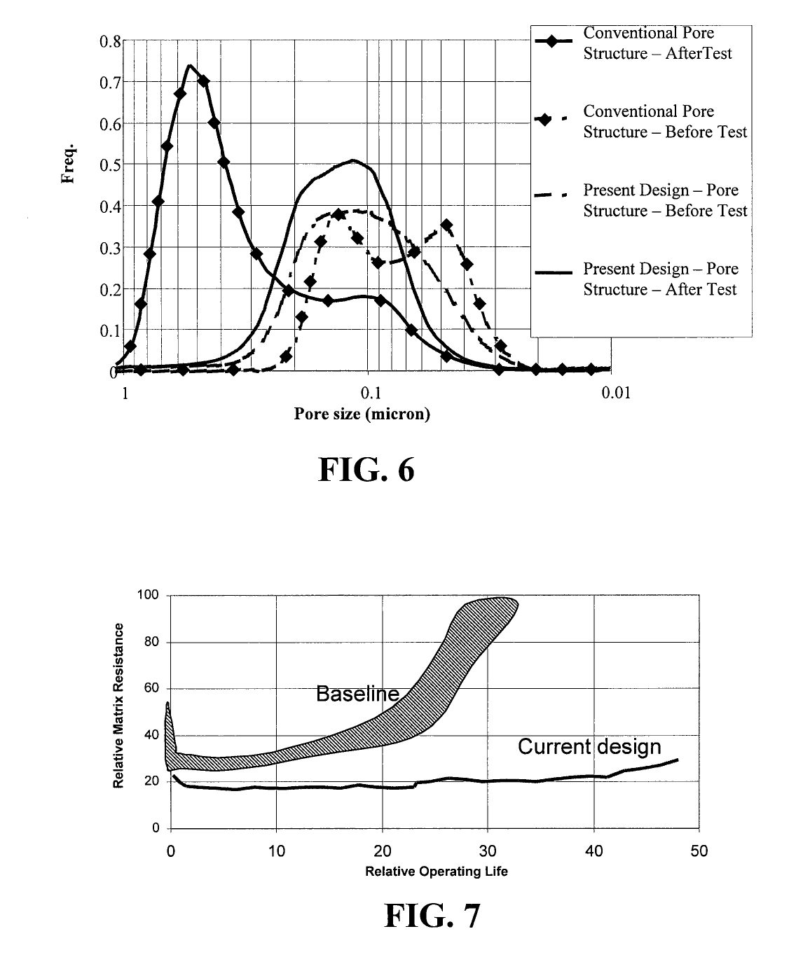

FIG. 6 shows a graph of pore size distribution data for electrolyte matrix tapes fabricated from the coated α-LiAlO₂ formed using the methods of FIGS. 2A and 2B before and after being used in the fuel cell and pore size distribution data for conventional electrolyte matrix tapes before and after being used in the fuel cell. In FIG. 6, X-axis represents the pore size in microns while Y-axis represents relative frequency. As can be seen in FIG. 6, the conventional electrolyte matrix tapes had a relatively broad, double-peak pore size distribution before being used in fuel cell testing. In particular, the conventional electrolyte matrix tapes have a frequent occurrence of pores having a pore size of about 0.15 microns and of about 0.05 microns. In contrast the matrix elements fabricated from the coated α-LiAlO₂ material of the present design have a single-peak narrower pore size distribution before being used in the fuel cell. As shown in FIG. 6, matrix elements fabricated from coated α-LiAlO₂ material had a frequent occurrence of pores having a size between 0.07 and 0.2 microns.

As also shown in FIG. 6, the pore size distribution in conventional matrix elements changed significantly after being used in the fuel cell tests. In particular, after being used in the fuel cell operating for 100 hours at 650° C., conventional matrix elements experienced significant pore growth, and as shown in FIG. 6, the most frequently occurring pores in conventional matrix elements after fuel cell testing had a pore size between 0.25 and 0.7 microns. Such pore growth over time results in a reduced electrolyte retention capability and a reduced mechanical integrity of the matrix, therefore negatively affecting fuel cell performance and operating life.

In contrast, matrix elements fabricated from the coated α-LiAlO₂ material experienced little or no pore growth after being used in the fuel cell operating for 100 hours at 650° C., such that the pore size distribution in these matrix elements remained substantially the same. This improvement in the relatively constant pore size distribution in the matrix elements formed from the coated α-LiAlO₂ materials results in improved mechanical integrity and electrolyte retention of the matrix, as well as increased operating life of the fuel cell and improved fuel cell performance over the operating life of the fuel cell.

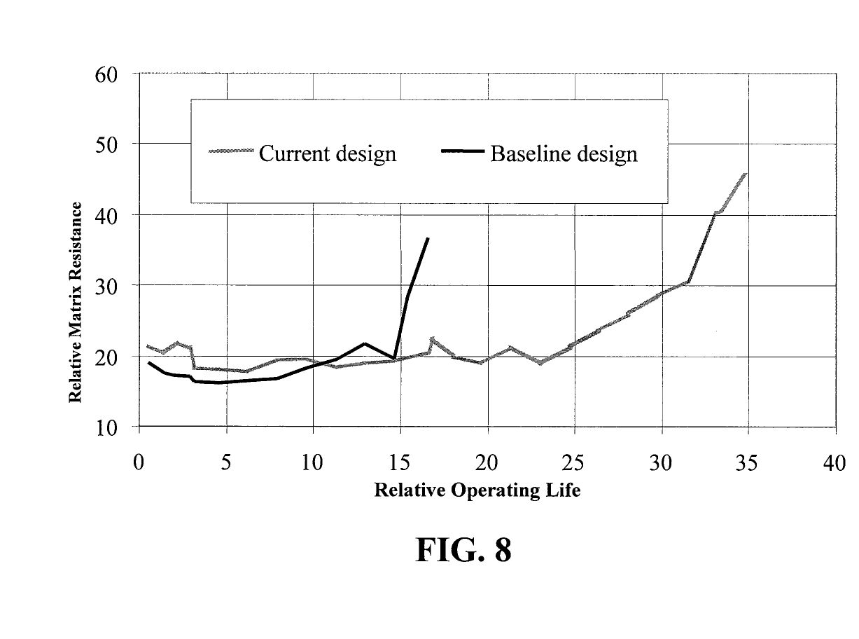

FIGS. 7 and 8 show graphs of cell resistance as a function of operating lifetime for single-cell fuel cells using conventional electrolyte matrices and using the matrices fabricated from coated α-LiAlO₂ material as described above with respect to FIGS. 2A and 2B. In particular, FIG. 7 shows a graph of relative resistance of the matrices tested in single cells operating at temperature of 650° C., while FIG. 8 shows a graph of relative resistance of the matrices tested in single cells under accelerated test conditions, wherein the single cells operated at 670° C. In both FIG. 7 and FIG. 8, the X-axis represents the operating life of the fuel cell in weeks, while the Y-axis represents the relative matrix resistance of the matrices being tested. The lifetimes of the fuel cells are determined based on the matrix resistance, which is inversely proportional to the electrolyte fill level in the cells, with a maximum resistance suitable for fuel cell operation being about 50 in a relative scale.

As shown in FIG. 7, the matrix resistance in single cells using conventional matrix elements remained constant for about 20-25 weeks and thereafter increased at a relatively high rate until reaching the maximum resistance after about 33 weeks. The matrix resistance in single cells using matrix elements fabricated from coated α-LiAlO₂ material in accordance with methods of FIGS. 2A-2B remained relatively constant for about 42 weeks and thereafter began to increase at a relatively slow rate.

Similarly, as shown in FIG. 8, the matrix resistance in single cells operating under accelerated test conditions and using conventional matrix elements remained relatively constant for about 14 weeks and increased thereafter at a high rate, reaching the maximum resistance at 37 weeks. In contrast, the matrix resistance in single cells using matrix elements fabricated from coated α-LiAlO₂ material using the methods of FIGS. 2A-2B remained relatively constant for about 25 weeks, and increased thereafter at a significantly slower rate than the resistance in the conventional single cells.

As can be seen from these results, the improved electrolyte retention by the matrices fabricated in accord with the invention results in a significant increase in the operating life of the fuel cells, nearly doubling the operating life of the cells. The operating life of the fuel cells is also extended by the improvement in the matrix strength and reduced risks of cracking.

In all cases it is understood that the above-described arrangements are merely illustrative of the many possible specific embodiments which represent applications of the present invention. Numerous and varied other arrangements can be readily devised in accordance with the principles of the present invention without departing from the spirit and the scope of the invention.

We claim:

1. A method of making a coated support material for use in fabricating a fuel cell matrix, comprising:
providing a support material;
providing an alkaline precursor material, said alkaline precursor material is one of soluble in water and having a melting point of 400° C. or less;
mixing said support material and said alkaline precursor material to form a mixture; and
processing the mixture to cause the alkaline precursor material to coat the support material to form said coated support material.

2. A method of making a coated support material in accordance with claim 1, wherein said support material comprises a porous ceramic material.

3. A method of making a coated support material in accordance with claim 2, wherein said support material comprises one of γ-LiAlO₂, α-LiAlO₂ and β-LiAlO₂.

4. A method of making a coated support material in accordance with claim 3, wherein said alkaline precursor material comprises at least one of alkaline hydroxide, alkaline isopropoxide, alkaline nitrate, alkaline acetate and alkaline oxalate.

5. A method of making a coated support material in accordance with claim 4, wherein said alkaline precursor material comprises one or more of lithium acetate, lithium acetate anhydrate, lithium oxalate, lithium nitrate and lithium hydroxide.

6. A method of making a coated support material in accordance with claim 2, wherein said alkaline precursor material is soluble in water and said processing said mixture comprises:
dispersing said mixture in water so as to dissolve said alkaline precursor material in water; and
drying said mixture so as to remove water and to form said coated support material.

7. A method of making a coated support material in accordance with claim 6, wherein said dispersing said mixture comprises blending said mixture in a predetermined amount of water for a predetermined time period and said drying comprises at least one of spray drying and heating for a predetermined time period.

8. A method of making a coated support material in accordance with claim 7, further comprising at least one of comminuting said coated support material and sieving said coated support material to eliminate particles larger than a predetermined size.

9. A method of making a coated support material in accordance with claim 8, wherein said comminuting comprises milling said coated support material.

10. A method of making a coated support material in accordance with claim 9, wherein:
said support material comprises α-LiAlO₂ powder having a first predetermined particle size and said alkaline precursor material comprises lithium acetate powder having a second predetermined particle size,
said mixture of said support material and said alkaline precursor material is dispersed in water by blending said mixture for 120 minutes; and
said dispersed mixture is dried by heating said mixture to 120° C. for a 24 hour time period and thereafter heating said mixture to 400° C. for a 1 hour time period under an air flow.

11. A method of making a coated support material in accordance with claim 10, wherein said first predetermined particle size is 0.09 micron and said second predetermined particle size is 50 microns or less, and wherein said support material comprises 50% of a total volume of said mixture and said alkaline precursor material comprises 50% of said total volume.

12. A method of making a coated support material in accordance with claim 11, wherein said comminuting comprises ball milling said coated support material using YTZ grinding media having 6 mm diameter.

13. A method of making a coated support material in accordance with claim 2, wherein said processing said mixture comprises heating said mixture to a predetermined temperature for a predetermined time period to melt said alkaline precursor material.

14. A method of making a coated support material in accordance with claim 13, wherein said processing further comprises cooling said mixture after said heating, and said method further comprising at least one of comminuting said coated support material and sieving said coated support material to eliminate particles larger than a predetermined size.

15. A method of making a coated support material in accordance with claim 14, wherein said predetermined temperature is between 60 and 400° C.

16. A method of making a coated support material in accordance with claim 15, wherein said support material comprises a powder having a particle size of 0.1 micron and said alkaline precursor material comprises a powder having a particle of 50 microns or less.

17. A method of making a coated support material in accordance with claim 16, wherein:
said support material comprises α-LiAlO₂ powder and said alkaline precursor material comprises lithium acetate powder, said support material comprising 85% of a total volume of said mixture and said alkaline precursor material comprising 15% of said total volume;
said support material and said alkaline precursor material are mixed using a blender for a time period of 30 minutes; and
said processing said mixture comprises heating the mixture to 65° C. for 3 hours and thereafter heating said mixture to 180° C. for 3 hours and cooling said mixture to room temperature.

18. A method of making a coated support material in accordance with claim 17, wherein said comminuting comprises ball milling said coated support material using YTZ grinding media having 6 mm diameter for a time period of 24 hours.

19. A method of making a coated support material in accordance with claim 16, wherein:
said support material comprises α-LiAlO₂ powder and said alkaline precursor material comprises lithium oxalate powder, said support material comprising 75% of a total volume of said mixture and said alkaline precursor material comprising 25% of said total volume;
said support material and said alkaline precursor material are mixed using a blender for a time period of 30 minutes; and
said processing said mixture comprises heating the mixture to 300° C. for 3 hours and thereafter heating said mixture to 400° C. for 1 hour and cooling said mixture to room temperature.

20. A method of making a coated support material in accordance with claim 19, wherein said comminuting comprises ball milling said coated support material using YTZ grinding media having 6 mm diameter for a time period of 24 hours.

21. A method of fabricating a matrix element for use in a fuel cell system comprising:
providing a coated support material formed from a support material and an alkaline precursor material, said alkaline precursor material being one of soluble in water and having a melting point of 400° C. or less;
providing a dispersant for dispersing said coated support material;
mixing said coated support material and said dispersant using a milling technique to form a mixture; and
forming said mixture into said matrix element.

22. A method of fabricating a matrix element for in accordance with claim 21, wherein said coated support material is formed by mixing said support material and said alkaline precursor material to form a precursor mixture and processing said precursor mixture to cause said precursor mixture to coat said support material by one of:
heating said precursor mixture to a predetermined temperature for a predetermined time period so as to melt said alkaline precursor material; and
dispensing said precursor mixture in water to dissolve said alkaline precursor material in water and drying said mixture to remove said water.

23. A method of fabricating a matrix element in accordance with claim 22, wherein said support material comprises LiAlO₂ and said alkaline precursor material comprises at least one of alkaline hydroxide, alkaline isopropoxide, alkaline nitrate, alkaline acetate and alkaline oxalate.

24. A method of fabricating a matrix element in accordance with claim 23, wherein said support material comprises one of γ-LiAlO₂, α-LiAlO₂ and β-LiAlO₂ having a particle size of 0.1 micron or less and said alkaline precursor material comprises one or more of lithium acetate, lithium acetate anhydrate, lithium oxalate, lithium nitrate and lithium hydroxide having a particle size of 50 microns or less.

25. A method of fabricating a matrix element in accordance with claim 24, further comprising at least one of comminuting said coated support material and sieving said coated support material to eliminate particles larger than a predetermined size prior to providing said coated support material.

26. A method of fabricating a matrix element in accordance with claim 25, wherein said comminuting comprises milling said coated support material using YTZ grinding media.

27. A method of fabricating a matrix element in accordance with claim 25, further comprising providing at least one additive component to said mixture of said coated support material and said dispersant and mixing said mixture with said at least one additive component.

28. A method of fabricating a matrix element in accordance with claim 27, wherein said additive component comprises aluminum powder.

29. A method of fabricating a matrix element in accordance with 27, wherein said mixing said mixture with at least one said additive component comprises milling said mixture and said at least one said additive component using a milling technique.

30. A method of fabricating a matrix element in accordance with claim 27, wherein said dispersant comprises at least one of fish oil and polymeric dispersant.

31. A method of fabricating a matrix element in accordance with claim 30, wherein said dispersant further comprises a binder material.

32. A method of fabricating a matrix element in accordance with claim 27, wherein said forming said matrix element comprise casting said mixture and then drying said cast mixture to form a tape element.

33. A fuel cell comprising:
an anode section;
a cathode section;
an electrolyte matrix disposed between said anode section and said cathode section, said electrolyte matrix comprising at least a support material; and
wherein said matrix is fabricated from a coated support material comprising said support material and an alkaline precursor material, said alkaline precursor material being one of soluble in water and having a melting point of 400° C. or less.

34. A fuel cell in accordance with claim 33, wherein said support material is LiAlO₂ and said alkaline precursor material comprises at least one of alkaline hydroxide, alkaline isopropoxide, alkaline nitrate, alkaline acetate and alkaline oxalate.

35. A fuel cell in accordance with claim 34, wherein said support material comprises one of γ-LiAlO₂, α-LiAlO₂ and β-LiAlO₂ having a particle size of 0.1 micron or less and said alkaline precursor material comprises one or more of lithium acetate, lithium acetate anhydrate, lithium oxalate, lithium nitrate and lithium hydroxide having a particle size of 50 microns or less.

36. A fuel cell in accordance with claim 35, wherein said coated support material is formed by mixing said support material and said alkaline precursor material to form a precursor mixture and processing said precursor mixture to cause said precursor material to coat said support material by one of:
heating said precursor mixture to a predetermined temperature for a predetermined time period so as to melt said alkaline precursor material; and
dispensing said precursor mixture in water to dissolve said alkaline precursor material in water and drying said mixture to remove said water.

37. A fuel cell in accordance with claim 36, wherein said heating comprises heating said precursor mixture to said predetermined temperature between 60 and 400° C.

38. A fuel cell in accordance with claim 36, wherein said forming said coated support material further comprises at least one of comminuting said coated support material and sieving said coated support material to eliminate particles larger than a predetermined size.

39. A fuel cell in accordance with claim 36, wherein said matrix is fabricated by mixing said coated support material with a dispersant to form a mixture, casting said mixture to form a tape element and drying said tape element to form said matrix.

40. A fuel cell in accordance with claim 39, wherein said dispersant comprises a binder and at least one of fish oil and a polymeric dispersant.

41. A fuel cell in accordance with claim 39, wherein said matrix is fabricated by further mixing said mixture with at least one additive component before casting said mixture and said additive component to form said matrix.

42. A fuel cell in accordance with claim 41, wherein said additive component comprises aluminum powder.

43. A coated support material for use in fabricating a fuel cell matrix comprising a support material and an alkaline precursor, said alkaline precursor being one of soluble in water and having a melting point of 400° or less, wherein said coated support material is formed by mixing said support material and said alkaline precursor material to form a mixture and by processing said mixture to cause said precursor material to coat said support material.

44. A coated support material in accordance with claim 43, wherein said support material comprises LiAlO₂ and said alkaline precursor material comprises at least one of alkaline hydroxide, alkaline isopropoxide, alkaline nitrate, alkaline acetate and alkaline oxalate.

45. A coated support material in accordance with claim 44, wherein said support material comprises one of γ-LiAlO₂, α-LiAlO₂ and β-LiAlO₂ having a particle size of 0.1 micron or less and said alkaline precursor material comprises one or more of lithium acetate, lithium acetate anhydrate, lithium oxalate, lithium nitrate and lithium hydroxide having a particle size of 50 microns or less.

46. A fuel cell in accordance with claim 45, wherein said processing of said alkaline precursor material comprises one of:
heating said precursor mixture to a predetermined temperature for a predetermined time period so as to melt said alkaline precursor material; and
dispensing said precursor mixture in water to dissolve said alkaline precursor material in water and drying said mixture to remove said water.

47. A fuel cell in accordance with claim 36, wherein said heating comprises heating said precursor mixture to said predetermined temperature between 60 and 400° C.
